(19) United States
(12) Patent Application Publication
(10) Pub. No.: US 2025/0309515 A1
(43) Pub. Date: Oct. 2, 2025

(54) LOSS REDUCTION AND IMPEDANCE ENGINEERING FOR CRYOGENIC APPLICATIONS

(71) Applicant: International Business Machines Corporation, Armonk, NY (US)

(72) Inventors: Sagarika Mukesh, ALBANY, NY (US); Thomas George McConkey, Long Island City, NY (US); Martin O. Sandberg, Ossining, NY (US); Rachel Sara Steiner, New York, NY (US)

(21) Appl. No.: 18/620,960

(22) Filed: Mar. 28, 2024

(51) Int. Cl. H01P 7/10; G06N 10/40; H01P 7/08; H01P 11/00

(52) U.S. Cl. CPC H01P 7/105; G06N 10/40; H01P 7/086; H01P 11/008

(57) ABSTRACT

An apparatus (e.g., microstrip or stripline) includes a signal line and a lower ground plane that is beneath, and spaced from, the signal line. A dielectric structure supports the signal line and is located at least partially between the lower ground plane and the signal line. The dielectric structure includes a dielectric material defining a plurality of voids and having a void percentage of at least 50%.

### BACKGROUND

The present invention relates to the electrical, electronic and computer arts, and more specifically, to quantum computing systems.

A quantum computer exploits quantum mechanics; i.e., the fact that, at small scales, matter exhibits both particle and wave properties. Quantum computers use qubits, analogous to the bit in conventional digital computing.

Qubits can be realized using many modalities. Some common modalities include superconducting qubits based on circuit quantum electrodynamics (cQED) architectures, trapped ion qubits, spin-based qubits, neutral atoms, or photonic qubits. A common modality is superconducting qubits. Superconducting qubit modalities require cooling to cryogenic temperatures, using a cryostat, a dilution refrigerator, or the like. One pertinent example of a superconducting qubit is the fixed-frequency transmon. Quantum computers operate via quantum logic gates between qubits. Such gates may employ, for example, a microwave-activated coupling, a fast tunable coupling, or a parametric coupling between the qubits that form the gate.

Multilevel wiring (MLW) provides an efficient way to route dense layouts and possibly provides a favorable electromagnetic environment in terms of signal fidelity. The MLW environment is inherently lossy. Recent hardware experiments have highlighted the problem of two-level system (TLS) saturation in such structures, hindering the calibration of qubits.

### SUMMARY

Principles of the invention provide techniques for loss reduction and impedance engineering for cryogenic applications. In one aspect, an exemplary apparatus includes a signal line; a lower ground plane beneath the signal line and spaced therefrom; and a dielectric structure supporting the signal line and located at least partially between the lower ground plane and the signal line. The dielectric structure includes a dielectric material defining a plurality of voids and having a void percentage of at least 50%.

In another aspect, an exemplary method includes providing a substrate; depositing a first metal layer on the substrate; depositing a first dielectric on the first metal layer; patterning and etching the first dielectric to create a plurality of first voids and a plurality of first dielectric islands; filling the plurality of first voids with a second dielectric to create a first intermediate structure; depositing a second metal layer on the first intermediate structure; patterning the second metal layer into at least a signal line to create a second intermediate structure; depositing a third dielectric on the second intermediate structure; patterning and etching the third dielectric to create a plurality of second voids and a plurality of second dielectric islands; filling the plurality of second voids with a fourth dielectric to create a third intermediate structure; depositing a third metal layer on the third intermediate structure; and selectively etching at least one of the first, second, third, and fourth dielectrics with respect to at least another one of the first, second, third, and fourth dielectrics to form a plurality of voids with a void percentage of at least 50%.

In still another aspect, another exemplary method includes obtaining a specification of an original distributed resonator layout characterized by a plurality of segments having corresponding segment shunt capacitance and segment inductance values, and at least first and second resonant modes, the specification including both geometry and materials; and modifying the original distributed resonator layout by changing at least one of the materials to change at least one of the segment shunt capacitance values or at least one of the segment inductance values, to obtain a modified distributed resonator layout with a change of frequency of at least one of the first and second resonant modes.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor and/or on remote circuit fabrication equipment, by sending appropriate data or commands to cause or aid the action to be performed. For the avoidance of doubt, where an actor facilitates an action by other than performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

FIGS. 1A and 1B are respective top and side views of an exemplary resonator structure in accordance with aspects of the invention;

FIGS. 2-18B depict steps in an exemplary method to fabricate a resonator structure in accordance with aspects of the invention, wherein FIG. 18B is a cross section along line XVIIIB-XVIIIB in FIG. 18A;

FIG. 19 shows that even in the case of an example non-ideality resulting from mask misalignment, a useful structure can still be obtained in accordance with aspects of the invention;

FIGS. 20A, 20B, 21, and 22 show that even in the case of an example non-ideality resulting from incomplete etching of the sacrificial dielectric, a useful structure can still be obtained in accordance with aspects of the invention, wherein FIG. 21 is a cross section along line XXI-XXI of FIG. 20B and FIG. 22 is a cross section along line XXII-XXII of FIG. 20B;

FIGS. 23-25 show an additional embodiment of another exemplary resonator structure in accordance with aspects of the invention, wherein FIG. 24 is a cross section along line XXIV-XXIV in FIG. 23, and FIG. 25 is a cross section along line XXV-XXV in FIG. 23;

FIGS. 26 and 27 show two examples of engineering frequency spacing of the first and second modes of a λ/2 distributed resonator via modification of the dielectric in accordance with aspects of the invention;

FIG. 28 shows an exemplary transmission line following the telegraph equation model, indicating the heterogenous characteristic impedance which occurs via modified layout geometry in accordance with aspects of the invention; and

FIG. 29 depicts a distributed resonator in accordance with aspects of the invention between first and second quantum computing elements.

### DETAILED DESCRIPTION

As noted above, while MLW provides an efficient way to route dense layouts and possibly provides a favorable electromagnetic environment in terms of signal fidelity, the MLW environment is inherently lossy, and recent hardware experiments have highlighted the problem of TLS saturation in such structures, hindering the calibration of qubits. One or more embodiments provide low-loss dielectrics which alleviate this problem and improve MLW performance using air gaps or the like.

Furthermore in this regard, a multilevel wiring structure in vacuum is ideal from a dielectric loss perspective for superconducting signal delivery. However, these structures are long (mm-scale) and typically need structural support, eliminating the option of hanging in vacuum. One or more embodiments advantageously form air gaps or the like in the existing structures as a “half-way point” between the ideal hanging in vacuum case and the non-ideal complete dielectric substrate.

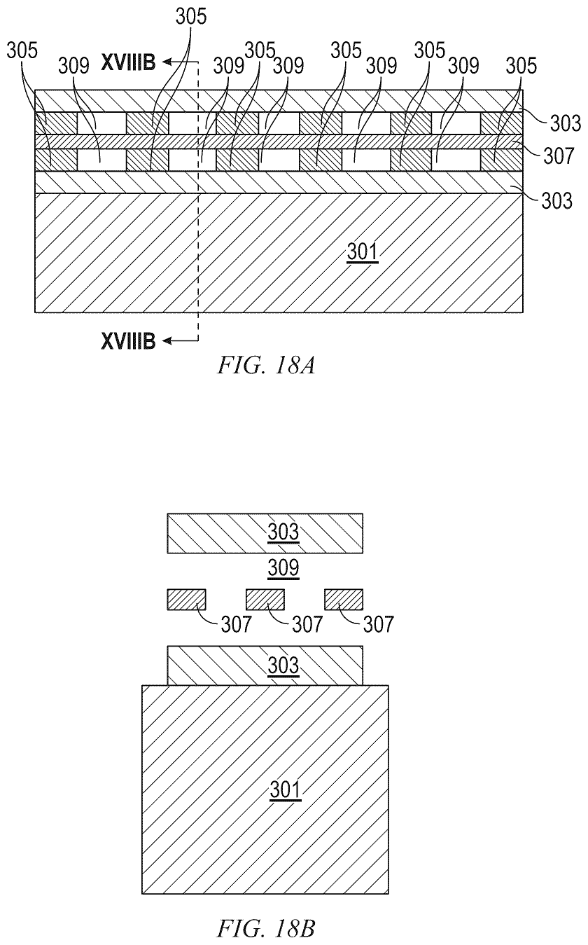

Given the discussion herein (reference characters refer to the drawings discussed below), it will be appreciated that, in one aspect, an exemplary apparatus (e.g., microstrip or part of a stripline) includes a signal line (middle line 307 in FIG. 18B); a lower ground plane (lower element 303) beneath the signal line and spaced from it; and a dielectric structure (blocks of 305 plus voids 309) supporting the signal line and located at least partially between the lower ground plane and the signal line. The dielectric structure includes a dielectric material defining a plurality of voids and having a void percentage of at least 50%. Technical benefits include improving the performance of resonators in quantum computing applications by decreasing dielectric losses; improving the performance of resonators in quantum computing applications by offsetting resonance modes; and improving resonator quality factor.

As used herein, the void percentage refers to the percentage of the nominal volume between the signal line (middle line 307 in FIG. 18B) and the lower ground plane 303 that is void. For example, in FIG. 18B, if the width of the middle line 307 is W, the height above the lower ground plane is H, and the depth into the paper is D, the nominal volume is WHD and the void percentage is the percentage that contains no dielectric. For example, in FIG. 18A, if the length of 305 and 309 is the same, the void percentage is 50%; if the length of 309 is double the length of 305, the void percentage is 67%. If there are both upper and lower ground planes, the void percentage further refers to the percentage of the nominal volume between the signal line (middle line 307 in FIG. 18B) and the upper ground plane 303 that is void.”

One or more embodiments, such as stripline, further include an upper ground plane (upper 303) above the signal line and spaced from it, where the dielectric structure surrounds the signal line and supports the signal line between the upper and lower ground planes. Technical benefits include the benefits discussed above achieved in a stripline that provides better shielding.

In some instances, the dielectric structure includes a plurality of spaced-apart dielectric support regions interspersed with the plurality of voids. Technical benefits include the benefits discussed above achieved in a configuration that can be readily manufactured.

In some such instances, the plurality of spaced-apart dielectric support regions are equally spaced. Technical benefits even more ready manufacturability because of the uniform spacing.

One or more embodiments further include a left ground plane (left element 307) and a right ground plane (right element 307) supported by the dielectric structure and spaced left and right of the signal line when viewed in a cross section transverse to a long axis of the signal line. Technical benefits include the benefits discussed above achieved in a structure that provides even better shielding.

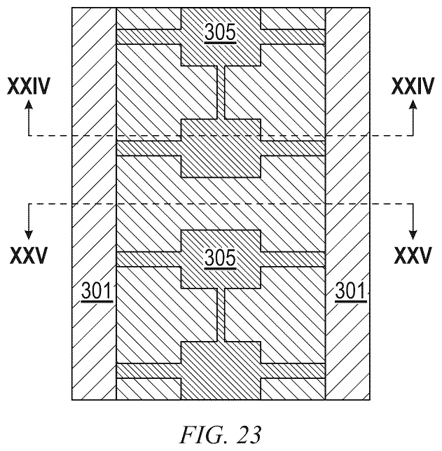

Referring, for example, to FIGS. 23-25, in some cases the left and right ground planes are fully supported by the dielectric structure. Technical benefits include even better shielding as discussed just above and in addition the side support allows for more voids around the signal line. Thus, there are one of more additional embodiments where, throughout the signal line, there is (almost) no dielectric and the side structures are used for support (however, occasional bridges are still needed to support the signal line). Thus, in this aspect, there is less dielectric below the signal line, with most dielectric under the ground planes. This aspect can have more than 50% voids, for example. Technical benefits include even better shielding as discussed just above and in addition the side support allows for more voids around signal line

In some cases, the plurality of voids are filled with air. Technical benefits include fabricability.

In some cases, the plurality of voids contain a vacuum. Technical benefits include enhanced compatibility with use under cryogenic temperatures.

In some embodiments, the dielectric material includes a plurality of portions that are rectangular in cross section when viewed in a cross section along the long axis of the signal line. Technical benefits include manufacturability of the voids.

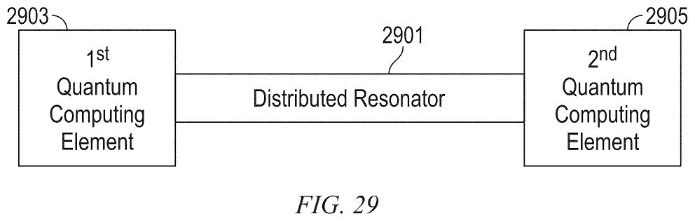

Referring to FIG. 29, in some embodiments, the signal line, the lower ground plane, the upper ground plane, and the dielectric structure have a length and first and second ends, and the apparatus further includes a first quantum computing element 2903 coupled to the first end and a second quantum computing element 2905 coupled to the second end. Generally, the coupling can be direct or indirect. Technical benefits include coupling quantum computing elements with a resonator 2901 having improved performance/improved quality factor.

In some such embodiments, at least one of the first and second quantum computing elements includes a physical manifestation of a qubit. Technical benefits include coupling a qubit to a quantum computing element with a resonator having improved performance/improved quality factor.

In some such embodiments, at least one of the first and second quantum computing elements incudes a readout port. Technical benefits include coupling a readout port to a quantum computing element with a resonator having improved performance/improved quality factor.

In some cases, at least one of the first and second quantum computing elements includes a transmission line. Technical benefits include coupling a resonator having improved performance/improved quality factor to a further upstream/downstream elements.

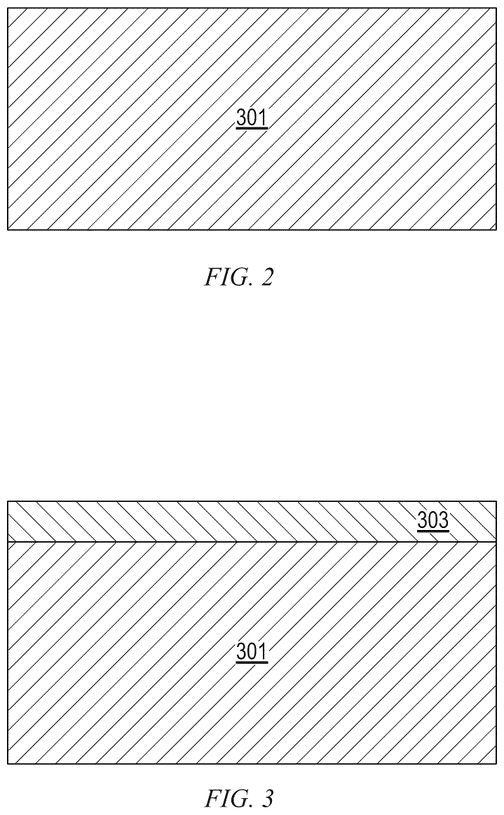

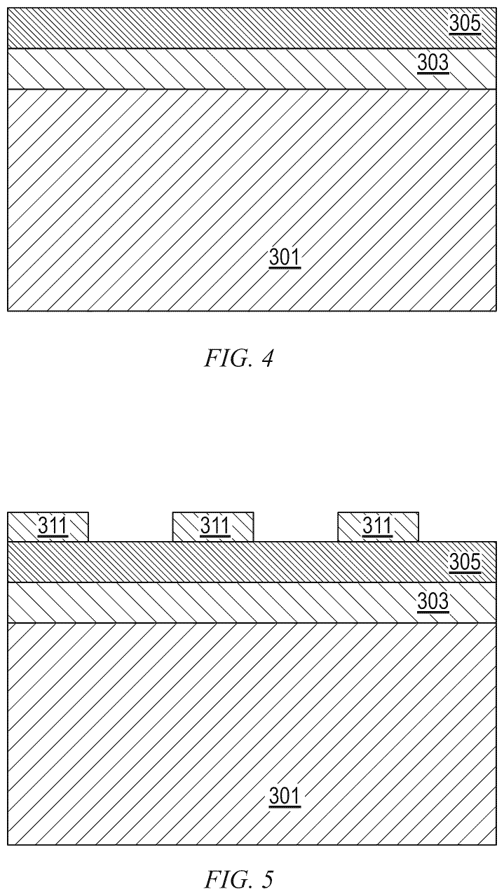

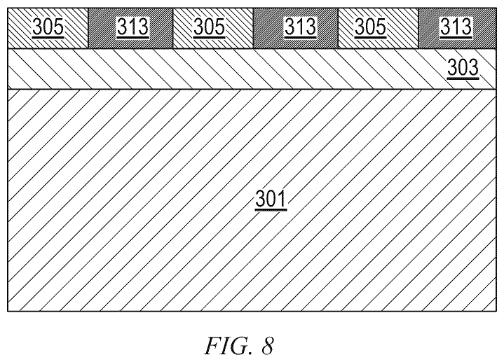

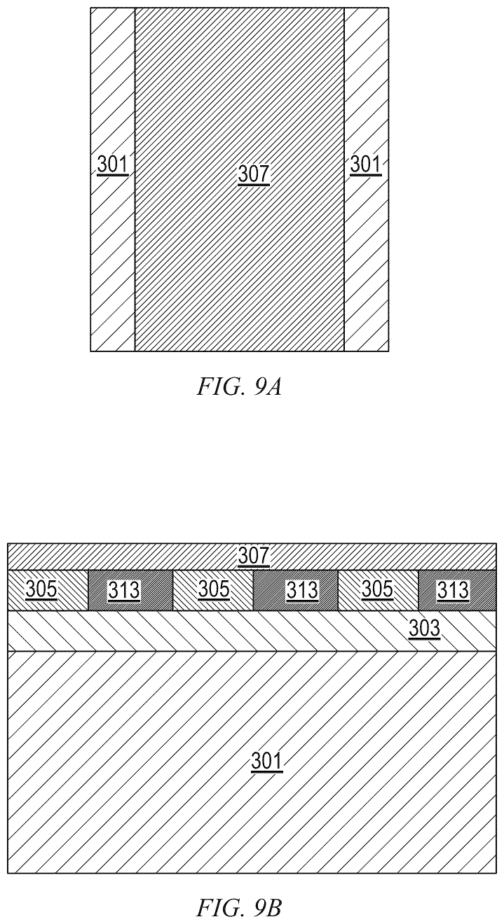

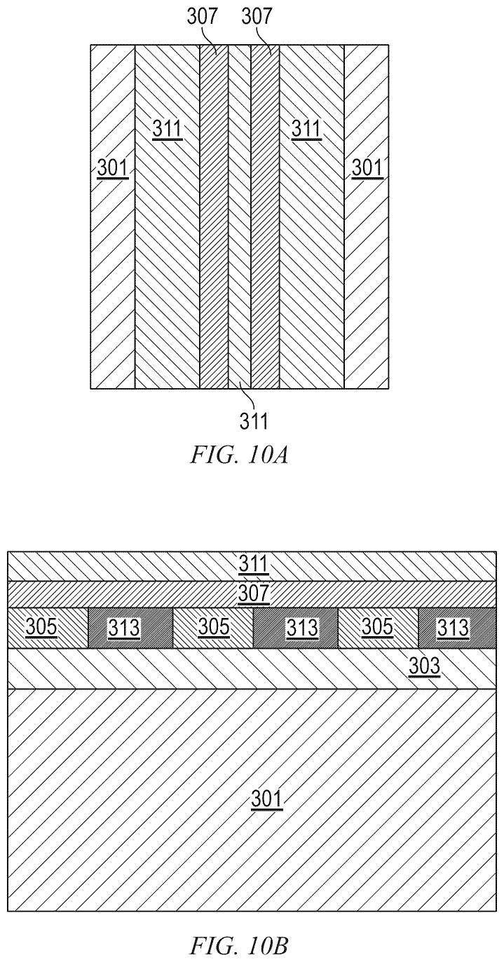

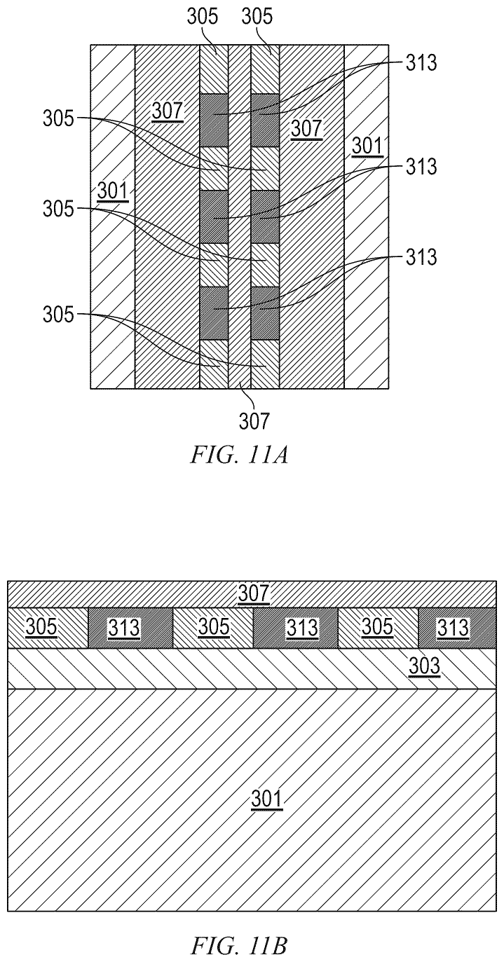

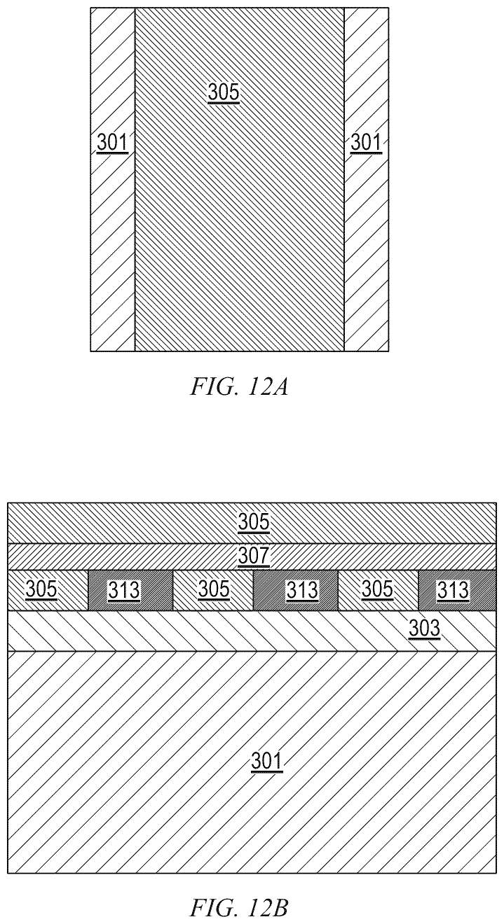

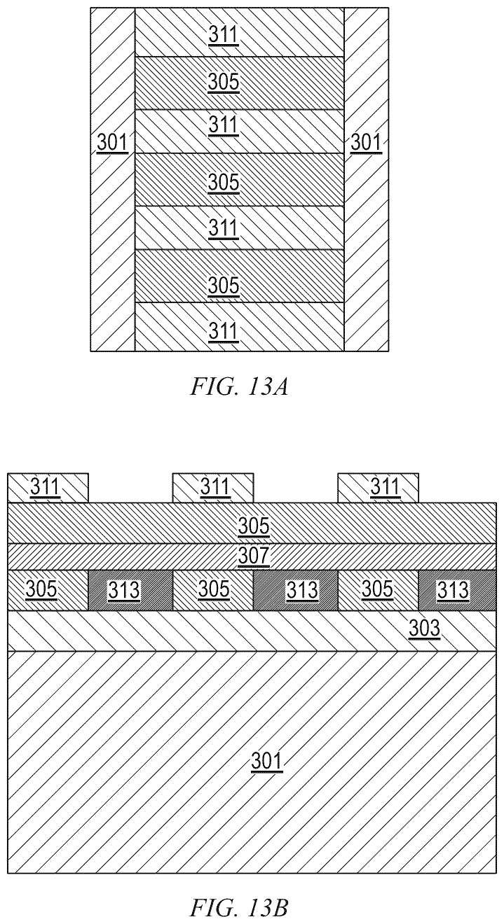

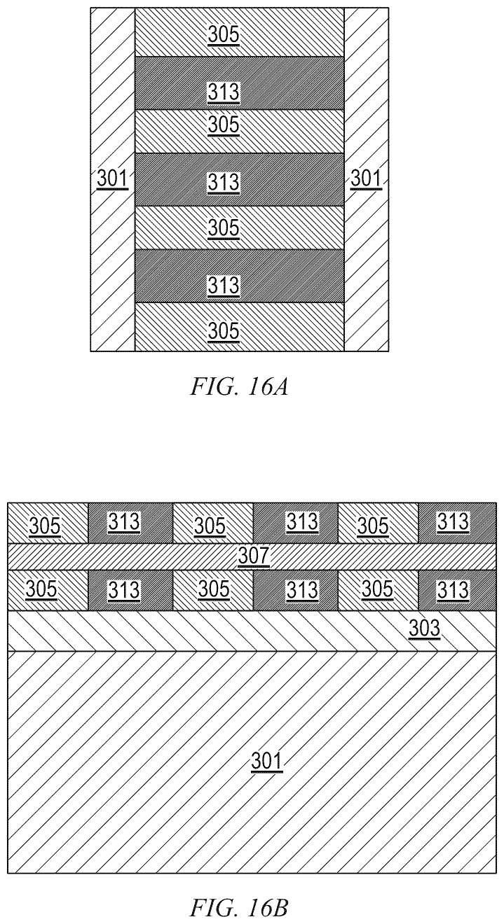

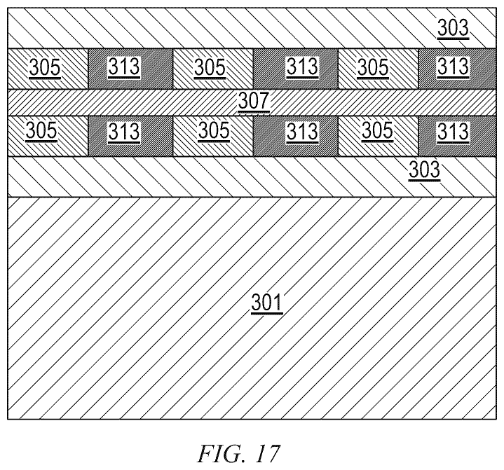

In another aspect, an exemplary method (e.g., using selective etching to make voids) includes providing a substrate, as in FIG. 2; depositing a first metal layer on the substrate, as in FIG. 3; depositing a first dielectric on the first metal layer, as in FIG. 4; patterning and etching the first dielectric to create a plurality of first voids and a plurality of first dielectric islands, as in FIGS. 5-7; and filling the plurality of first voids with a second dielectric to create a first intermediate structure, as in FIG. 8. Further steps include depositing a second metal layer on the first intermediate structure, as in FIGS. 9A and 9B; patterning the second metal layer into at least a signal line to create a second intermediate structure, as in FIGS. 10A-11B; depositing a third dielectric on the second intermediate structure, as in FIGS. 12A and 12B; patterning and etching the third dielectric to create a plurality of second voids and a plurality of second dielectric islands, as in FIGS. 13A-15B; filling the plurality of second voids with a fourth dielectric to create a third intermediate structure, as in FIGS. 16A and 16B; depositing a third metal layer on the third intermediate structure, as in FIG. 17; and selectively etching at least one of the first, second, third, and fourth dielectrics with respect to at least another one of the first, second, third, and fourth dielectrics to form a plurality of voids with a void percentage of at least 50%. Technical benefits include a way to manufacture a resonator with improved performance in quantum computing applications by decreasing dielectric losses and/or offsetting resonance modes and/or with improvement to resonator quality factor.

In some cases, the second and fourth dielectrics are the same; and the first and third dielectrics are the same. Technical benefits include simplified manufacturing.

In some such cases, the second and fourth dielectrics include sacrificial material; and the selective etching includes selectively etching the sacrificial material with respect to the first and third dielectrics. Technical benefits include ready manufacturability using a selective etching process.

In some instances, patterning the second metal layer further includes patterning the second metal layer into left and right ground planes. Technical benefits include providing an end product with better shielding.

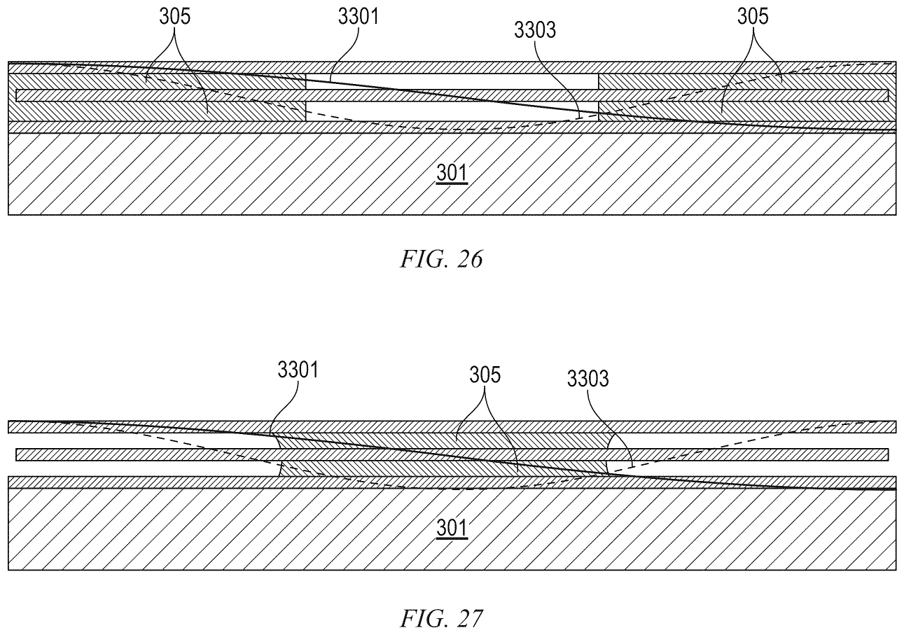

In still another aspect, referring to FIGS. 26-28, an exemplary method is provided (e.g., for providing impedance engineering as a design technique). The method includes obtaining a specification of an original distributed resonator layout characterized by a plurality of segments having corresponding segment shunt capacitance and segment inductance values, and at least first and second resonant modes. The specification includes both geometry and materials. The method further includes modifying the original distributed resonator layout by changing at least one of the materials to change at least one of the segment shunt capacitance values or at least one of the segment inductance values, to obtain a modified distributed resonator layout with a change of frequency of at least one of the first and second resonant modes. Technical benefits include improving the technological process of designing resonators in quantum computing applications.

One or more embodiments further include fabricating a distributed resonator in accordance with the modified distributed resonator layout. Technical benefits include providing an end product with improved performance.

In one or more embodiments, the fabricating of the distributed resonator includes fabricating at least a portion of a travelling wave parametric amplifier (TWPA); technical benefits include those discussed above, achieved in connection with a travelling wave parametric amplifier (TWPA).

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improves the performance of resonators in quantum computing applications by decreasing dielectric losses;
improves the performance of resonators in quantum computing applications by offsetting resonance modes;
improves resonator quality factor;
improves the technological process of designing resonators in quantum computing applications.

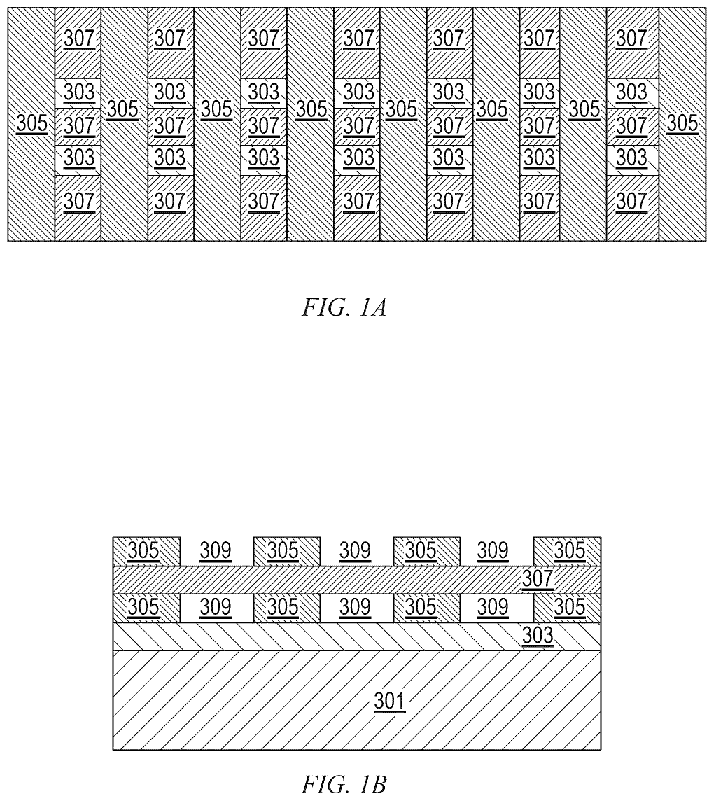

Referring to FIGS. 1A and 1B, one or more embodiments form a resonator structure with air gaps using, for example, steps including laying down a desired dielectric over a substrate with ground plane, patterning the desired dielectric, etching it, and filling the gaps with a sacrificial dielectric; laying down the signal line, patterning it, and etching it; repeating the process on a second layer of dielectric; and finally etching out the sacrificial material. More details are provided below beginning with FIG. 2. FIGS. 1A and 1B are respective top and side views. Note the substrate 301, ground plane/line 303, preferred dielectric 305, signal lines 307, and air gaps 309 (generally can include air, another gas/mixture of gases, or vacuum). Regarding the sacrificial material, in one or more embodiments, this material: should etch selective to the main dielectric, should work with a wet-etch or vapor etch chemistry, and damage to the surrounding structure should be minimal. Note that the signal lines and ground planes are shown with a different cross hatching pattern, but the same material can optionally be used for both. Generally, a suitable superconducting material can be employed, such as niobium, aluminum, tantalum, and titanium nitride.

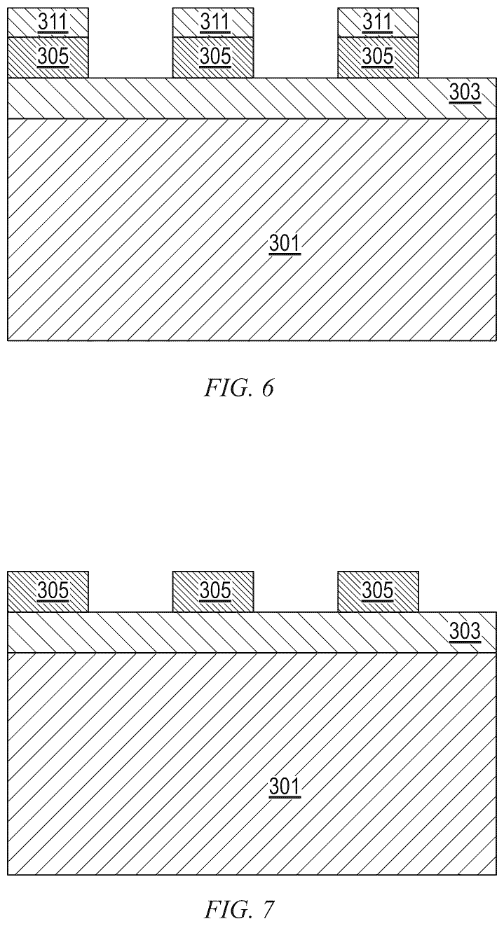

Consider now an exemplary fabrication process. In FIG. 2, provide a substrate 301 (e.g., wafer such as silicon or the like). In FIG. 3 deposit metal 303 for the bottom ground plane. Please note that no patterning of the metal 303 is depicted at this stage, but such patterning could optionally be performed (although this would require further resist steps in the process as would be apparent to the skilled artisan given the teachings herein). In FIG. 4, deposit preferred dielectric 305. In FIG. 5, pattern the bottom dielectric 305; note the (patterned) organic planarization layer (OPL) 311. In FIG. 6, etch the bottom dielectric 305 that is not protected by the OPL 311. In FIG. 7, remove the OPL by ashing.

Patterning of various layers as described herein can be carried out with known lithographic and etching techniques.

In FIG. 8, fill the regions where the OPL was removed with second (sacrificial) dielectric 313 and planarize. In FIGS. 9A and 9B, deposit metal 307 for the signal line. Note that FIGS. 9A, 10A, 11A, 12A, 13A, 14A, 15A, and 16A are top views of FIGS. 9B, 10B, 11B, 12B, 13B, 14B, 15B, and 16B. In FIGS. 10A and 10B, apply OPL 311 and pattern the signal line(s). In FIGS. 11A and 11B, carry out etching for the signal line(s), and remove the OPL by ashing. FIGS. 11A and 11B thus depict the pattern after signal level metal etching and OPL ashing. As best seen in FIG. 11A, even on the signal level, there are four directions of ground plane. The narrow middle region of 307 is a signal line while the left and right thick regions of 307 are ground plane and there is ground plane 303 below and above the signal line. Therefore, a well-protected electromagnetic environment is provided.

In FIGS. 12A and 12B, fill in the top level dielectric 305.

Note that the top views 10A, 13A, and 14A include OPL 311.

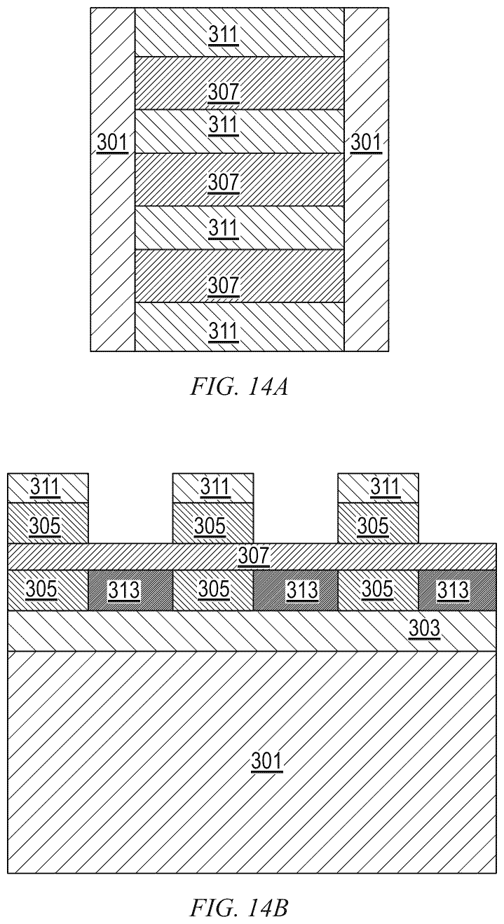

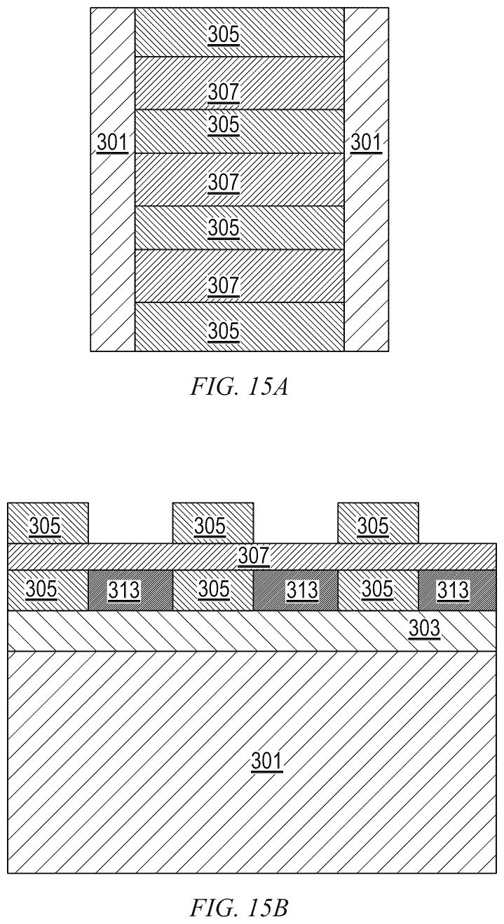

In FIGS. 13A and 13B, deposit OPL 311 and pattern same. In FIGS. 14A and 14B, etch the top level dielectric 305 that is not protected by the OPL. In FIGS. 15A and 15B, remove the OPL by ashing. In FIGS. 16A and 16B, fill the regions where the OPL was removed with second dielectric 313 and planarize. In FIG. 17, deposit a top layer of ground metal 303. In FIG. 18A, etch away the sacrificial dielectric to form the air gaps 309. Generally, either of the two dielectrics can be selectively etched as desired. FIG. 18B is a cross section taken along line XVIIIB-XVIIIB in FIG. 18A.

Considering the sacrificial dielectric material, the same should etch selective to the main dielectric; in one or more embodiments, via a wet etch or vapor etch. Damage to the surrounding structure should be minimal. Exemplary pairs of (main dielectric, sacrificial dielectric) include: (SiOₓ, SiN); (SiOₓ, Tetraethyl orthosilicate, formally named tetraethoxysilane (TEOS)); (SiN, SiOₓ); (SiOₓ, a-Si (amorphous silicon)); (SiOₓ, poly silicon), and the like.

The final structure thus includes the bottom ground plane 303, signal line 307, top ground plane 303, air gapped dielectric 305 (air gaps are 309) and thus reduced dielectric presence around the signal line.

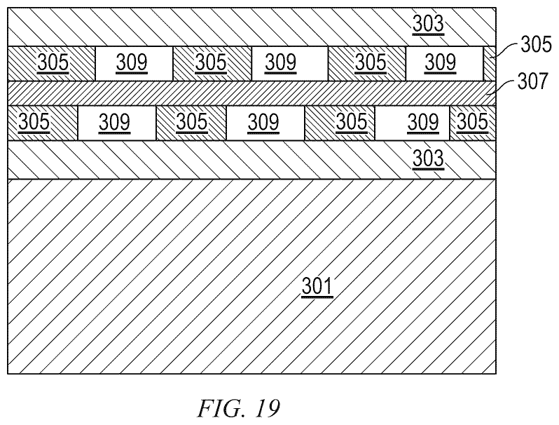

FIG. 19 shows an example non-ideality resulting from mask misalignment. The edges of the top and bottom level dielectric are misaligned and the air gaps above and below the signal line 307 are misaligned; however, this does not matter because the air gaps are still present.

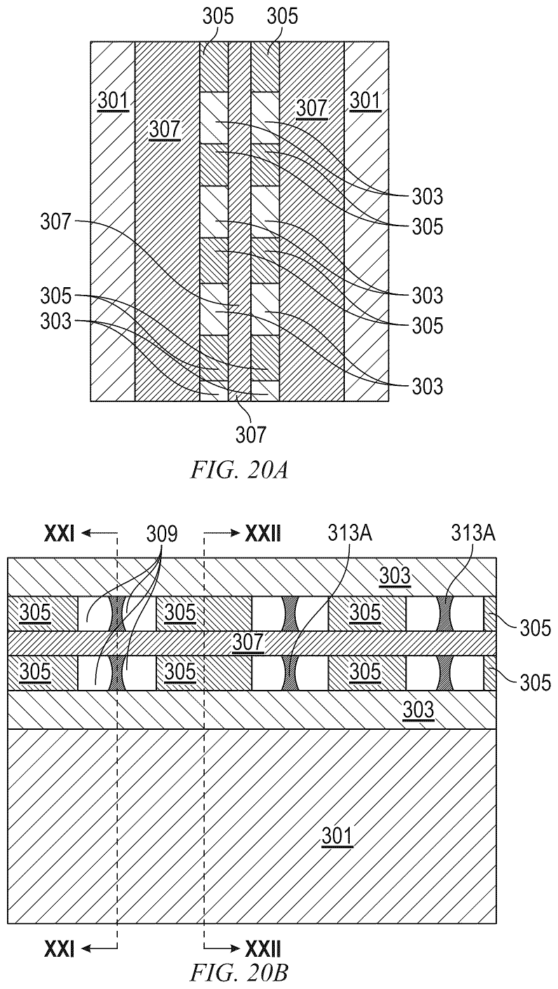

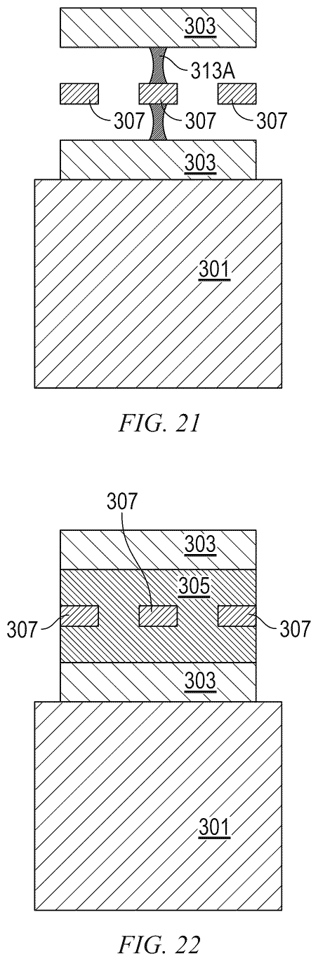

FIGS. 20A, 20B, 21, and 22 show an example non-ideality resulting from incomplete etching of the sacrificial dielectric. FIG. 21 is a cross-section along line XXI-XXI in FIG. 20B and FIG. 22 is a cross-section along line XXII-XXII in FIG. 20B. Remaining “nub” portions of sacrificial dielectric are labeled as 313A. However, this does not matter because a significant amount of the dielectric has still been eliminated.

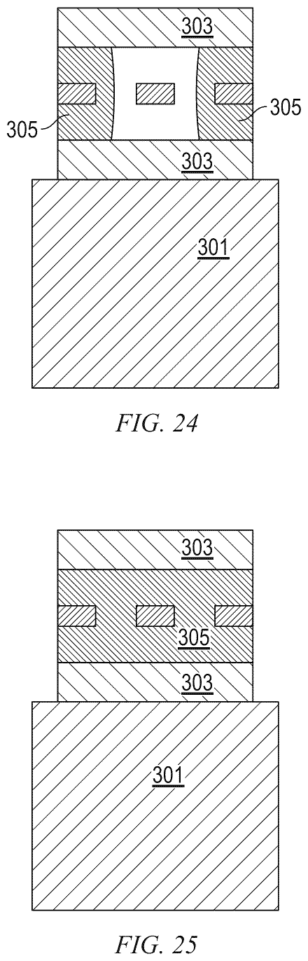

FIGS. 23-25 show an additional embodiment; FIG. 24 is a cross section along line XXIV-XXIV in FIG. 23, and FIG. 25 is a cross section along line XXV-XXV in FIG. 23. In the additional embodiment, pattern and etch the channels so that only the dielectric near the signal line is etched. That is to say, the left and right ground planes are completely embedded in dielectric along their lengths as seen in FIGS. 24 and 25 while the signal line is largely surrounded by an air gap but with periodic dielectric support. In FIGS. 23-25, it can be seen that the dielectric can potentially be made even more sparse, such as skipping every other or every third dielectric layer. In FIG. 24, note the side dielectrics supporting the ground plane and the skipping of a few bridges for an ever sparser dielectric layer.

One or more embodiments advantageously provide improvement in the quality factor. Based on finite element results for a λ/2 (lambda is wavelength) resonator with continuous lossy dielectric compared to a λ/2 resonator with etched out regions of lossy dielectric, we compared simulation-predicted frequency (GHz) and quality factor (Q) for the first and second Eigenmodes for a no air gap case and an air gap case. We found that the Eigenfrequency and Q value increase; while the increase in Q is desirable, the change in Eigenfrequency may be undesirable, since it may be desirable to target certain frequencies. We have found that this situation can be remedied by changing the length of the resonator to bring down the Eigenfrequency without materially changing the quality factor. Thus, it is possible to change the length of the resonator to achieve the same frequency as in the no air gap case with little or no change in quality factor. Lengthening the line thus lowers the frequency without deteriorating the quality factor.

Note that λ/2 is a non-limiting specific example and other cases are possible; for example, λ/4.

It will be appreciated that one or more embodiments provide a new type of transmission line.

Aspects of the invention can also be employed to provide impedance engineering. In this aspect, the modification of the dielectric leads to changes of the relative permittivity seen by the transmission line, or alternatively can be thought of as leading to changes of shunt capacitance to the impacted sections of the transmission line. This leads to a heterogenous impedance structure to the transmission line, which when properly designed, enables design dynamics for the electrical behavior, such as the harmonics of a resonator. In one or more exemplary cases, the impedance engineering can be achieved through two different approaches: (i) modification of the dielectric so as to change the permittivity in targeted locations; and (ii) modification of the layout so as to change the shunt capacitance in target locations.

Thus, it is possible to change the dielectric that is around the conductor (e.g., by introducing air gaps), so as to impact the electrical permittivity. In another aspect, it is possible to make changes to just the actual physical layout of the structure without any changes to the dielectric. Consider, for example, changing the shunt capacitance. This can be done by making changes to the dielectric, since the dielectric is largely just impacting the relative permittivity. However, this can also be done by changing the location-specific spacing between the trace and the ground plane.

FIGS. 26 and 27 show two examples of engineering the frequency spacing of the first and second modes of a λ/2 distributed resonator via modification of the dielectric. FIG. 26 leads to the second mode being higher than two times the first mode frequency. FIG. 27 leads to the second mode being lower than two times the first mode frequency. Both cases are due to the middle voltage antinode of the second mode being exposed to a different relative permittivity than what the first mode is (for the most part) “seeing.”

Still referring to FIGS. 26 and 27, consider changes to the physical configuration of the dielectric and consider the first two modes of a resonant structure (first mode (cos(x))=3301, second mode (cos(2x))=3303). The electric field will interact with the dielectric differently depending on what part of the dielectric has been removed. If the dielectric in the middle of the resonator is removed as in FIG. 26, the impact to the resonance mode for the first mode is minimal because for the first mode, there is little electric field present in the middle of resonator. However, there is more impact for the second mode because there is more of an interaction with the changed permittivity. By removing dielectric in the middle as in FIG. 26 as opposed to at the ends as in FIG. 27, the frequency separation can be changed between the first and second modes.

One or more embodiments provide techniques for impedance engineering by modifying the layout. For example, a first mode can be relatively indifferent to a changed layout, while the second mode is significantly shifted. The shunt capacitance of the transmission line can be modified, for example, in a region where the electric field is minimal, but where roughly half of the electric field of the second mode is present.

For example, instead of removing dielectric, for a middle section, modify the spacing of the shunt capacitance that the resonator is seeing. In a non-limiting example, based on simulations, the first mode is at about 7.3 GHZ; the second mode is at about 8.9 GHz, and so on. By changing the shunt capacitance in the middle region, the first mode increases very slightly, but the higher-order modes, since they do have electric fields in that modified region, experience higher jumps in frequency, demonstrating the possibility of modifying the harmonic spacing between the modes of interest.

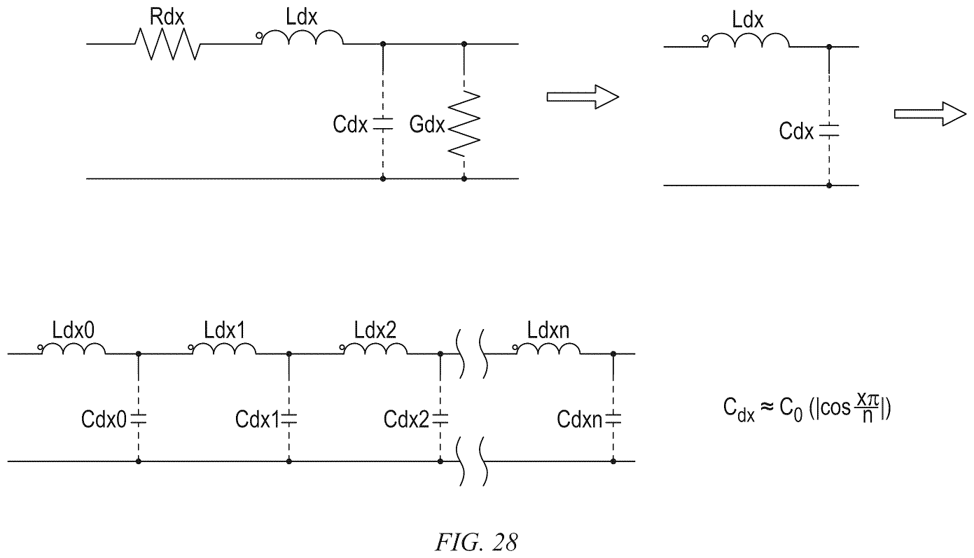

FIG. 28 shows an exemplary transmission line following the telegraph equation model, indicating the heterogenous characteristic impedance which occurs via modified layout geometry in accordance with aspects of the invention (and a simplified manner of, for example, targeting separation of the first and second mode). Depending on the desired effect, optimal modification can be achieved by appropriate layout modification, taking into account the field distribution of the modes of interest. Consider an isolated distributed resonator via the telegraph equation; according to the telegraph equation, the elementary components of a transmission line can be schematically represented as a resistance R per unit length dx, inductance L per unit length dx, conductance G per unit length dx, and shunt capacitance C per unit length dx. Ignoring R and G for simplicity (ignoring G and R in the telegraph equation is standard practice), and extending for the length of the resonator, the elementary components can be simplified to inductance L per unit length dx and shunt capacitance C per unit length dx, for each of a plurality of infinitesimal segments dx0, dx1, dx2, . . . , dxn. Given that the field distribution can be analytically determined or simulated (both before and after any layout modifications), the local inductance and capacitance can be optimally modified such that the first mode is minimally impacted by the changes, yet the second mode experiences a significantly different impedance, leading to a much higher or lower resonance frequency than from the initial layout. A simplistic example could be considered, such as at the bottom of FIG. 28, where Cdx can be approximated as shown.

Furthermore in this regard, the exemplary approach of FIG. 28 provides a simple way to generate infinitesimal capacitance of a transmission line structure so as to influence the second mode of the resonant structure while having minimal impact to the first mode. Referring to the bottom left-hand portion of FIG. 28, consider a distributed λ½ resonator. The two ends are open terminations, so, in essence, for each step of the shunt capacitance to ground, its value is determined by where along the transmission line it is located, such that there will be very little shunt capacitance to ground in the middle and maximal towards the ends. Accordingly, the first mode will have minimal influence to its state with that modification while the second mode will have significant impact to its state and will rise to a much higher frequency. The first mode will stay relatively static. For example, to bring the modes closer, it would be appropriate to place the dielectric material where the electric field interacts the most for the second mode but the least for the fundamental (first) mode (and the opposite is true where it is desired to separate the modes). In one or more embodiments, the change of permittivity is significant.

Still with reference to FIG. 28, C_{dx0}, C_{dx1}, C_{dx2}, . . . , C_{dxn} are the capacitance values for respective infinitesimal lengths of transmission line. C₀ is the inherent capacitance determined for the structure; in this example, the shunt capacitance to ground at the extreme ends of the resonator. The parameter x is the segment number and n is the total number of segments.

It will thus be appreciated that one aspect of one or more embodiments is the application of specific modifications to a distributed resonator structure to optimize the separation of the harmonic modes. One pertinent application is to travelling wave parametric amplifiers (TWPAs) and the like. One or more embodiments include modification of the distributed resonator layout so as to change the shunt capacitance in target locations; for example, the local inductance and capacitance can be optimally modified such that the first mode is minimally impacted by the changes, yet the second mode experiences a significantly different impedance, leading to a much higher or lower resonance frequency than from the initial layout. Indeed, in one or more embodiments, a distributed resonant structure is modified for the purpose of intentionally changing the spacing between the modes of resonance by modifying the local impedance at sections of the distributed resonant structure. For example, changes can be made from a simplistic co-planar waveguide (CPW) strip line resonator so as to have heterogenous impedance with the goal and purpose of changing the frequency separation of the modes of the resonator. One or more embodiments advantageously modify the distributed resonator layout to change the frequency of at least one of the first and second resonant modes.

Optimized modification of shunt capacitance and series inductance to achieve idealized separations of different resonant modes can thus be provided in one or more embodiments; e.g., optimizing the harmonic separation between the first and second modes. Instead of providing a rectangular cutout in the middle of the resonator as at the top of FIG. 27, provide curvature to optimize the impact to the second order mode while minimizing impact to the first/primary mode, for example.

Thus, one or more embodiments etch out parts of the dielectric of the MLW to offset resonance modes and/or to decrease dielectric losses. One or more embodiments provide a method and structure to form resonators with selectively removed dielectric areas to reduce TLS losses resulting from the dielectric and/or to change the resonant frequency of the higher order harmonics through relative permittivity modifications, for improved performance of the resonator. At least some embodiments provide a structure with a discontinuous dielectric layer supporting the signal line of a resonator for lower dielectric loss and/or a structure where the etched-out dielectric and/or the conductive material is designed to change the resonant frequency of the higher order harmonics through relative permittivity/local impedance modifications. One or more embodiments improve dielectric loss in MLW.

One or more embodiments thus provide structures to route signals to qubits; the structures include, for example, two ground planes and a signal plane (some embodiments include four ground planes). In conventional structures, the presence of dielectric around the signal line results in some losses. One aspect of the invention includes creating a structure with air gaps, to reduce the amount of dielectric around the signal line. One or more embodiments provide: (i) a method to reduce losses in dielectric around the signal line; and/or (ii) a method to tune the higher order harmonics through relative permittivity/local impedance modifications.

It will be appreciated that MLW provides an efficient way to route dense layouts and possibly provides a better electromagnetic environment in terms of signal fidelity. Also, the MLW environment is inherently lossy. Moreover, recent hardware experiments have highlighted the problem of two-level system (TLS) saturation in such structures, hindering the calibration of qubits. Low-loss dielectrics as disclosed herein alleviate this problem.

One or more embodiments provide a signal carrying structure including a signal line located between a first ground plane and a second ground plane; a dielectric (e.g., solid dielectric material) separating the signal line from the first ground plane and the second ground plane in a first portion of the signal carrying structure; and an air gap (or vacuum gap or gap filled with other gas or gaseous mixture) separating the signal line from the first ground plane and the second ground plane in a second portion of the signal carrying structure.

One or more embodiments provide techniques for formation of a dielectric that includes air gaps and supports an embedded signal line with ground planes on top, bottom, and on the sides. One or more embodiments provide a structure that achieves low-loss high density routing for superconducting qubit chips.

Unlike some prior art techniques that are solely for surface devices, relying on simple over etching in order to remove dielectric in the gap region of a co-planar waveguide (CPW) transmission line, one or more embodiments employ techniques appropriate for use in MLW type structures.

Referring now to FIG. 29, one or more embodiments provide a distributed resonator 2901 that interconnects first and second quantum computing elements 2903, 2905. Here, for example, the signal line, the lower ground plane, the upper ground plane (when present), the left and right ground planes (when present), and the dielectric structure have a length and first and second ends. The apparatus then further includes the first quantum computing element 2903 coupled to the first end of resonator 2901 and the second quantum computing element 2905 coupled to the second end of resonator 2901. The coupling can be direct or indirect; i.e., there can be other elements between the first end of resonator 2901 and the first quantum computing element 2903 and/or there can be other elements between the second end of resonator 2901 and the second quantum computing element 2905.

It is worth noting that two-level systems (TLS) typically occur when a dielectric is involved. For example, consider a superconducting metal with a dielectric around it. The two-level systems tend to exist on the interfaces. Molecular impurities are also pertinent to TLS (e.g., dangling bonds or other phenomena resulting in energy gaps in the frequency range of operation due to the material interaction/interfacing between a superconductor and a dielectric or the like or due to impurities embedded in the materials-TLS are extra-prevalent in amorphous materials, sputtered materials, etc.). One or more embodiments provide a significant benefit in applications that cannot ensure epitaxial materials. Reactive ion etching (RIE) may also cause TLS. Amorphous dielectrics and sputtered materials are vulnerable.

It will be appreciated that there are many possible use cases and many different types of quantum computing elements possible. For example, there can be a physical manifestation of a qubit at each end of resonator 2901; a transmission line at each end; a qubit at one end and a readout port at the other end; and so on (e.g., the qubit could be “two steps down the line” from the end of the resonator). The structure 2901 itself could be a readout resonator, a bus structure, a filter, a straight-up transmission line, a coupler, or the like. In one or more embodiments, the inventive structure is part of an overall qubit system.

In some instances, distributed resonator 2901 carries signals for a quantum processing unit; say to a qubit, to a coupler, in between different resonators, for signal delivery, or the like. In some instances, one end is coupled to a quantum computing signal source (various non-limiting examples are disclosed herein), and the other end is coupled to a quantum computing signal sink—in some cases, a sink could sometimes be a source and vice versa. It should also be noted that there can be more than two elements to a resonator; indeed, for example, 3, 4, or 5 elements could be connected to a resonator. Note that capacitive or inductive couplings can be located at various locations on the resonator. Coupling can be direct or indirect. For example, a signal source can be off chip, at room temperature outside the cryostat, with intervening connections to the resonator 2901. The elements can include ports, signal input/output, and the like.

A quantum computing processor is typically passive and signals are applied to it to manipulate it—it does not generate any signals of its own. Quantum computing elements 2903, 2905 can generally be passive or active. Resonator 2901 can also provide a connection between a first port and a second port. Elements 2903, 2905 could also include parametric amplifiers, for example.

Accordingly, in some instances, at least one of the first and second quantum computing elements 2903, 2905 includes a physical manifestation of a qubit; in some instances, at least one of the first and second quantum computing elements includes a readout port; and in some instances, at least one of the first and second quantum computing elements includes a transmission line.

Semiconductor device manufacturing includes various steps of device patterning processes. For example, the manufacturing of a semiconductor chip may start with, for example, a plurality of CAD (computer aided design) generated device patterns, which is then followed by effort to replicate these device patterns in a substrate. The replication process may involve the use of various exposing techniques and a variety of subtractive (etching) and/or additive (deposition) material processing procedures. For example, in a photolithographic process, a layer of photo-resist material may first be applied on top of a substrate, and then be exposed selectively according to a pre-determined device pattern or patterns. Portions of the photo-resist that are exposed to light or other ionizing radiation (e.g., ultraviolet, electron beams, X-rays, etc.) may experience some changes in their solubility to certain solutions. The photo-resist may then be developed in a developer solution, thereby removing the non-irradiated (in a negative resist) or irradiated (in a positive resist) portions of the resist layer, to create a photo-resist pattern or photo-mask. The photo-resist pattern or photo-mask may subsequently be copied or transferred to the substrate underneath the photo-resist pattern.

There are numerous techniques used by those skilled in the art to remove material at various stages of creating a semiconductor structure. As used herein, these processes are referred to generically as “etching”. For example, etching includes techniques of wet etching, dry etching, chemical oxide removal (COR) etching, and reactive ion etching (RIE), which are all known techniques to remove select material(s) when forming a semiconductor structure. The Standard Clean 1 (SC1) contains a strong base, typically ammonium hydroxide, and hydrogen peroxide. The SC2 contains a strong acid such as hydrochloric acid and hydrogen peroxide. The techniques and application of etching is well understood by those skilled in the art and, as such, a more detailed description of such processes is not presented herein.

Although the overall fabrication method and the structures formed thereby are novel, certain individual processing steps required to implement the method may utilize conventional semiconductor fabrication techniques and conventional semiconductor fabrication tooling. These techniques and tooling will already be familiar to one having ordinary skill in the relevant arts given the teachings herein. Moreover, one or more of the processing steps and tooling used to fabricate semiconductor devices are also described in a number of readily available publications, including, for example: James D. Plummer et al., Silicon VLSI Technology: Fundamentals, Practice, and Modeling 1st Edition, Prentice Hall, 2001 and P. H. Holloway et al., Handbook of Compound Semiconductors: Growth, Processing, Characterization, and Devices, Cambridge University Press, 2008, which are both hereby incorporated by reference herein. It is emphasized that while some individual processing steps are set forth herein, those steps are merely illustrative, and one skilled in the art may be familiar with several equally suitable alternatives that would be applicable.

It is to be appreciated that the various layers and/or regions shown in the accompanying figures may not be drawn to scale. Furthermore, one or more semiconductor layers of a type commonly used in such integrated circuit devices may not be explicitly shown in a given figure for ease of explanation. This does not imply that the semiconductor layer(s) not explicitly shown are omitted in the actual integrated circuit device.

Those skilled in the art will appreciate that the exemplary structures discussed above can be distributed in raw form (i.e., a single wafer having multiple unpackaged chips), as bare dies, in packaged form, or incorporated as parts of intermediate products or end products that benefit from use of one or more aspects of the disclosed backside gate tie-down in backside power distribution network (BSPDN) architecture.

An integrated circuit in accordance with aspects of the present inventions can be employed in essentially any application and/or electronic system where one or more aspects of the disclosed backside gate tie-down in backside power distribution network (BSPDN) architecture would be beneficial. Given the teachings of the present disclosure provided herein, one of ordinary skill in the art will be able to contemplate other implementations and applications of embodiments disclosed herein.

The illustrations of embodiments described herein are intended to provide a general understanding of the various embodiments, and they are not intended to serve as a complete description of all the elements and features of apparatus and systems that might make use of the circuits and techniques described herein. Many other embodiments will become apparent to those skilled in the art given the teachings herein; other embodiments are utilized and derived therefrom, such that structural and logical substitutions and changes can be made without departing from the scope of this disclosure. It should also be noted that, in some alternative implementations, some of the steps of the exemplary methods may occur out of the order noted in the figures. For example, two steps shown in succession may, in fact, be executed substantially concurrently, or certain steps may sometimes be executed in the reverse order, depending upon the functionality involved. The drawings are also merely representational and are not drawn to scale. Accordingly, the specification and drawings are to be regarded in an illustrative rather than a restrictive sense.

Embodiments are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Terms such as “bottom”, “top”, “above”, “over”, “under” and “below” are used to indicate relative positioning of elements or structures to each other as opposed to relative elevation. If a layer of a structure is described herein as “over” another layer, it will be understood that there may or may not be intermediate elements or layers between the two specified layers. If a layer is described as “directly on” another layer, direct contact of the two layers is indicated. As the term is used herein and in the appended claims, “about” means within plus or minus ten percent.

The corresponding structures, materials, acts, and equivalents of any means or step-plus-function elements in the claims below are intended to include any structure, material, or act for performing the function in combination with other claimed elements as specifically claimed. The description of the various embodiments has been presented for purposes of illustration and description, but is not intended to be exhaustive or limited to the forms disclosed. Many modifications and variations will be apparent to those of ordinary skill in the art without departing from the scope and spirit thereof. The embodiments were chosen and described in order to best explain principles and practical applications, and to enable others of ordinary skill in the art to understand the various embodiments with various modifications as are suited to the particular use contemplated.

The abstract is provided to comply with 37 C.F.R. § 1.76(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, the claimed subject matter may lie in less than all features of a single embodiment. Thus, the following claims are hereby incorporated into the Detailed Description, with each claim standing on its own as separately claimed subject matter.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus comprising:
a signal line (middle 307);
a lower ground plane (lower 303) beneath the signal line and spaced therefrom;
a dielectric structure (blocks of 305 plus voids 309) supporting the signal line and located at least partially between the lower ground plane and the signal line, the dielectric structure including a dielectric material defining a plurality of voids and having a void percentage of at least 50%.

2. The apparatus of claim 1, further comprising an upper ground plane (upper 303) above the signal line and spaced therefrom, wherein the dielectric structure surrounds the signal line and supports the signal line between the upper and lower ground planes.

3. The apparatus of claim 2, wherein the dielectric structure includes a plurality of spaced-apart dielectric support regions interspersed with the plurality of voids.

4. The apparatus of claim 3, wherein the plurality of spaced-apart dielectric support regions are equally spaced.

5. The apparatus of claim 3, further comprising a left ground plane (left 307) and a right ground plane (right 307) supported by the dielectric structure and spaced left and right of the signal line when viewed in a cross section transverse to a long axis of the signal line.

6. The apparatus of claim 5, wherein the left and right ground planes are fully supported by the dielectric structure.

7. The apparatus of claim 3, wherein the plurality of voids are filled with air.

8. The apparatus of claim 3, wherein the plurality of voids contain a vacuum.

9. The apparatus of claim 3, wherein the dielectric material includes a plurality of portions that are rectangular in cross section when viewed in a cross section along the long axis of the signal line.

10. The apparatus of claim 2, wherein the signal line, the lower ground plane, the upper ground plane, and the dielectric structure have a length and first and second ends, further comprising a first quantum computing element (2903) coupled to the first end and a second quantum computing element (2905) coupled to the second end.

11. The apparatus of claim 10, wherein at least one of the first and second quantum computing elements comprises a physical manifestation of a qubit.

12. The apparatus of claim 10, wherein at least one of the first and second quantum computing elements comprises a readout port.

13. The apparatus of claim 10, wherein at least one of the first and second quantum computing elements comprises a transmission line.

14. A method comprising:
providing a substrate;
depositing a first metal layer on the substrate;
depositing a first dielectric on the first metal layer;
patterning and etching the first dielectric to create a plurality of first voids and a plurality of first dielectric islands;
filling the plurality of first voids with a second dielectric to create a first intermediate structure;
depositing a second metal layer on the first intermediate structure;
patterning the second metal layer into at least a signal line to create a second intermediate structure;
depositing a third dielectric on the second intermediate structure;
patterning and etching the third dielectric to create a plurality of second voids and a plurality of second dielectric islands;
filling the plurality of second voids with a fourth dielectric to create a third intermediate structure;
depositing a third metal layer on the third intermediate structure; and
selectively etching at least one of the first, second, third, and fourth dielectrics with respect to at least another one of the first, second, third, and fourth dielectrics to form a plurality of voids with a void percentage of at least 50%.

15. The method of claim 14, wherein:
the second and fourth dielectrics are the same; and
the first and third dielectrics are the same.

16. The method of claim 15, wherein:
the second and fourth dielectrics comprise sacrificial material; and
the selective etching comprises selectively etching the sacrificial material with respect to the first and third dielectrics.

17. The method of claim 14, wherein patterning the second metal layer further comprises patterning the second metal layer into left and right ground planes.

18. A method comprising:
obtaining a specification of an original distributed resonator layout characterized by a plurality of segments having corresponding segment shunt capacitance and segment inductance values, and at least first and second resonant modes, the specification including both geometry and materials;
modifying the original distributed resonator layout by changing at least one of the materials to change at least one of the segment shunt capacitance values or at least one of the segment inductance values, to obtain a modified distributed resonator layout with a change of frequency of at least one of the first and second resonant modes.

19. The method of claim 18, further comprising fabricating a distributed resonator in accordance with the modified distributed resonator layout.

20. The method of claim 19, wherein the fabricating of the distributed resonator comprises fabricating at least a portion of a travelling wave parametric amplifier (TWPA).
